(19) United States
(12) Patent Application Publication
(10) Pub. No.: US 2004/0054983 A1
(43) Pub. Date: Mar. 18, 2004

(54) Information processing apparatus, information providing apparatus, information processing system, information processing method, program, and recording medium

(75) Inventor: Toshiyuki Noguchi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/657,209

(22) Filed: Sep. 9, 2003

(30) Foreign Application Priority Data
Sep. 13, 2002 (JP) 2002-268831

(51) Int. Cl. G06F 9/44

(52) U.S. Cl. 717/100

(57) ABSTRACT

There are provided an information processing apparatus, information providing apparatus, information processing system, and information processing method which can reflect the intentions of the operator of the information providing apparatus and reduce the loads associated with processing in a server without harming user's convenience. For example, the information providing apparatus transmits the first list data to the information processing apparatus. The information processing apparatus causes a function expansion program for a browser to acquire the second list data from the information processing apparatus and create the third list data on the basis of the acquired second list data and the first list data transmitted by the transmission unit, thereby causing the browser to display the window based on the created third list data.

### FIELD OF THE INVENTION

The present invention relates to an information processing apparatus, information providing apparatus, information processing system, information processing method, program, and recording medium which properly process information between apparatuses connected through a network.

### BACKGROUND OF THE INVENTION

Conventionally, in order to print image data stored in a server connected through a network by using a printer connected to a client terminal, the client terminal creates a printing operation user interface window which allows designation of all printing conditions such as printers that can be used for printing and paper sizes, and a WWW browser displays the window.

Conventionally, however, when the client terminal is to create a printing condition setting user interface of a printing operation window to be displayed on the WWW browser, printing conditions cannot be limited from the server. In general, the client terminal can hold limitation of printing conditions in advance and create a printing condition selection list. However, it is impossible to execute printing easily from the client terminal on the basis of printing conditions such as a printer and paper suitable for a printing application on the server.

### SUMMARY OF THE INVENTION

The present invention has been proposed to solve the conventional problems, and has as its objects to provide an information processing apparatus, information providing apparatus, information processing system, information processing method, program, and recording medium which can ensure security on the client side, reflect the intentions of the operator of a server, and reduce the load on processing in the server without harming user's convenience.

In order to achieve the above object, according to the present invention, there is provided an information processing apparatus for processing information written in a language which can describe design of a window to be displayed by a browser, comprising reception means for receiving first list data transmitted from another apparatus connected through a network, and storage means for storing a function expansion program for the browser, the function expansion program including acquisition unit adapted to acquire second list data, and creation unit adapted to create the information for causing the browser to display a window based on the second list data acquired by the acquisition unit and the first list data received by the reception means.

The information processing apparatus according to the present invention, wherein the function expansion program for the browser further comprises computation unit adapted to perform a set operation between the second list data acquired by the acquisition means and the first list data received by the reception means, and the creation unit creates on the basis of an operation result obtained by the computation unit.

The information processing apparatus according to the present invention, wherein the apparatus can be connected to at least one printing apparatus through a network, and the acquisition means acquires the second list data on the basis of information obtained from at least one of an operating system and control software for the printing apparatus.

The information processing apparatus according to the present invention, wherein the function expansion program for the browser further comprises second information creation means for creating the information for causing the browser to display an input window for various conditions for printing processing executed by the printing apparatus on the basis of the first and second list data.

The information processing apparatus according to the present invention, wherein each of the first list data and the second list data lists at least one of information about a model of the printing apparatus, information about a paper size for printing by the printing apparatus, information about a paper type for printing by the printing apparatus, and information about a layout for printing by the printing apparatus.

In addition, according to the present invention, there is provided an information providing apparatus connected to a client apparatus through a network, comprising storage means for storing first list data to be used by a function expansion program for a browser in the client apparatus which stores the second list data, and transmission means for transmitting, through a network, at least one of information written in a language which can describe design of a window to be displayed by the browser and the first list data stored in the storage means in accordance with a request from the client apparatus.

The information providing apparatus according to the present invention further comprises second storage means for storing image data, reception means for receiving input information input in accordance with a window displayed by the browser in the client apparatus which can be connected to at least one printing apparatus through a network, and second transmission means for transmitting the image data to the client apparatus on the basis of the input information received by the reception means.

The information providing apparatus according to the present invention, wherein each of the first list data, the second list data, and third list data lists at least one of information about a model of the printing apparatus, information about a paper size for printing by the printing apparatus, information about a paper type for printing by the printing apparatus, and information about a layout for printing by the printing apparatus.

Furthermore, according to the present invention, there is provided an information processing system in which an information providing apparatus and an information processing apparatus can communicate with each other through a network, wherein the information providing apparatus comprises first storage means for storing first list data, and transmission means for transmitting the first list data stored in the first storage means in accordance with a request from the information processing apparatus, and the information processing apparatus comprises second storage means for storing a function expansion program for the browser, the function expansion program including acquisition unit adapted to acquire second list data, and creation unit adapted to create the information for causing the browser to display a window based on the second list data acquired by the acquisition unit and the first list data received by the reception means.

Moreover, according to the present invention, there is provided an information processing method in an information processing apparatus which processes information written in a language which can describe design of a window to be displayed by a browser and stores second list data, comprising a reception step of receiving first list data transmitted from another apparatus connected through a network, an acquisition step of acquiring the second list data according to a function expansion program for the browser, a creation step of creating information for causing the browser to display a window based on the second list data acquired in the acquisition step and the first list data received in the reception step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, server to explain the principles of the invention.

FIG. 1 is a view showing the arrangement of an information processing system having an information processing apparatus according to the first embodiment of the present invention;

FIG. 2 is a block diagram showing the arrangement of a client terminal apparatus according to the first embodiment of the present invention;

FIG. 3 is a view showing an example of an album display window according to the first embodiment;

FIG. 4 is a view showing an example of a printing operation window according to this embodiment;

FIG. 5 is a flow chart for explaining a printing sequence in a client terminal apparatus according to the first embodiment;

FIG. 6 is a flow chart for explaining a procedure for printing operation window HTML template creation in a server apparatus according to the first embodiment;

FIG. 7 is a flow chart for explaining a sequence for printing operation window creation in a plug-in in the client terminal apparatus according to the first embodiment;

FIG. 8 is a view showing an example of a window to be displayed on a WWW browser on the basis of printing operation window HTML data according to the first embodiment of the present invention;

FIG. 9 is a flow chart for explaining a sequence for printing condition selection list creation which is plug-in processing in an information processing apparatus according to the first embodiment of the present invention;

FIG. 10 is a view showing an example of data for explaining printing condition selection list creation processing which is plug-in processing in the information processing apparatus according to the first embodiment of the present invention;

FIG. 11 is a view showing the arrangement of an information processing system having an information processing apparatus according to the second embodiment, of the present invention;

FIG. 12 is a flow chart for explaining a printing sequence in a client terminal apparatus 1411 according to the second embodiment of the present invention; and

FIG. 13 is a flow chart for explaining a sequence for printing operation window creation in a plug-in in the client terminal apparatus according to the second embodiment of the present invention.

### DETAILED DESCRIPTION OF THE PREFERRED EMBODIMENTS

An embodiment of the present invention will be described in detail below with reference to the accompanying drawings.

<First Embodiment>

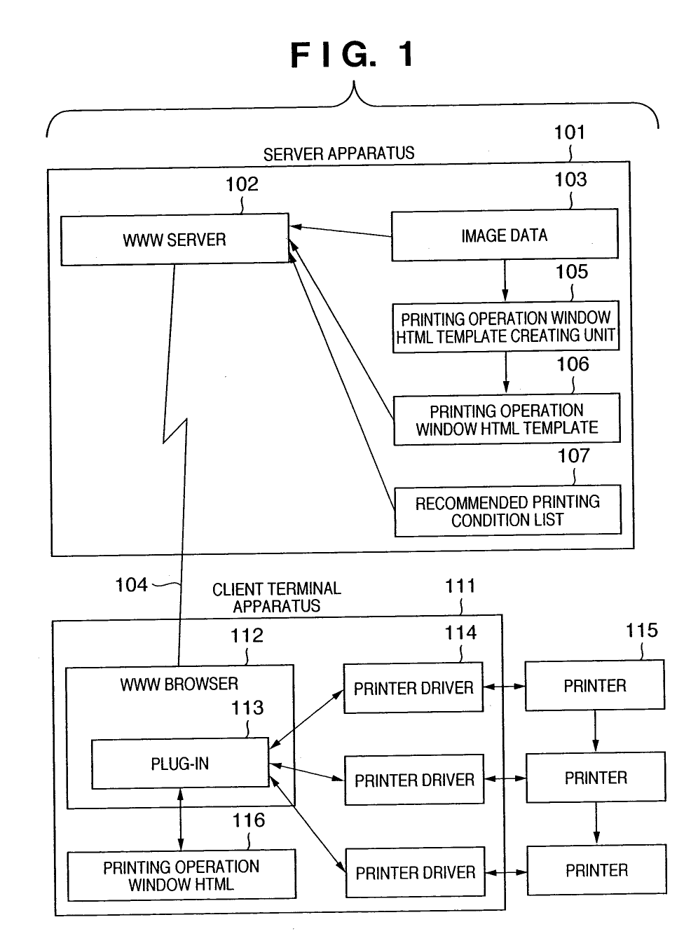

FIG. 1 is a view showing the arrangement of an information processing system having an information processing apparatus according to the first embodiment of the present invention. Referring to FIG. 1, reference numeral 111 denotes a client terminal apparatus which implements an information processing apparatus according to this embodiment. The client terminal apparatus 111 is connected to a server apparatus 101 through a network 104 such as the Internet or a local area network (LAN).

Reference numeral 112 denotes a WWW browser which operates on the client terminal apparatus 111. The WWW browser 112 has a function of interpreting a file written in HTML (Hyper Text Markup Language) and acquired from a WWW serer 102 on the server apparatus 101 through the network 104, and displaying the resultant information on the display unit (CRT 201 to be described later) of the client terminal apparatus 111.

Reference numeral 113 denotes a function expansion unit (plug-in) for expanding the function of the WWW browser 112. Assume that when the WWW browser 112 interprets an HTML file, there is a description which designates the execution of the plug-in 113. In this case, the plug-in 113 corresponding to the contents of the description is executed by the WWW browser 112.

Reference numeral 114 denotes a printer driver to which the plug-in 113 gives a print request through the operating system (OS). The printer driver 114 interprets the print instruction received from the plug-in 113 through the OS and performs printing processing with respect to a printer 115. Note that a plurality of printers 115 can be connected to the client terminal apparatus 111, and there are a plurality of printer drivers 114 required for the respective printers.

Reference numeral 103 denotes image data stored in a storage unit in the server apparatus 101, a storage unit connected to the server apparatus 101, or the like. Assume that the WWW browser 112 on the client terminal apparatus 111 gives the WWW server 102 on the server apparatus 101 a request to display the image data 103 through the network 104. At this time, the WWW serer 102 prepares an HTML file to display the image data 103 on the server apparatus 101 and returns the file to the WWW browser 112 through the network 104. The WWW browser 112 displays the received HTML file on the display unit. This makes it possible to display the image data 103 on the display unit of the client terminal apparatus 111.

Reference numeral 105 denotes a printing operation window HTML template creating unit having a function of extracting an image necessary to display a printing operation window based on a predetermined HTML from the image data 103, and creating an HTML serving as a user interface other than the printing condition setting user interface portion required for a printing operation window.

Reference numeral 106 denotes a printing operation window HTML template, which is created by the printing operation window HTML template creating unit 105. The printing operation window HTML template 106 is transmitted from the WWW server 102 of the server apparatus 101 to the plug-in 113 of the client terminal apparatus 111 in accordance with the request from the plug-in 113 of the client terminal apparatus 111. The plug-in 113 then adds the printing condition setting interface portion to the received printing operation window HTML template 106, thereby creating a printing operation window HTML 116. .This allows the printing operation window to be displayed on the WWW browser 112.

Reference numeral 107 denotes a recommended printing condition list (first list data), which is set in advance, in the server apparatus 101 and transmitted in accordance with a request from the plug-in 113. In the client terminal apparatus 111, printing conditions recommended from the server side to the user can be presented, which are referred to by the plug-in 113 when it creates a printing condition selection list (choices of printing conditions) of printing condition setting interfaces.

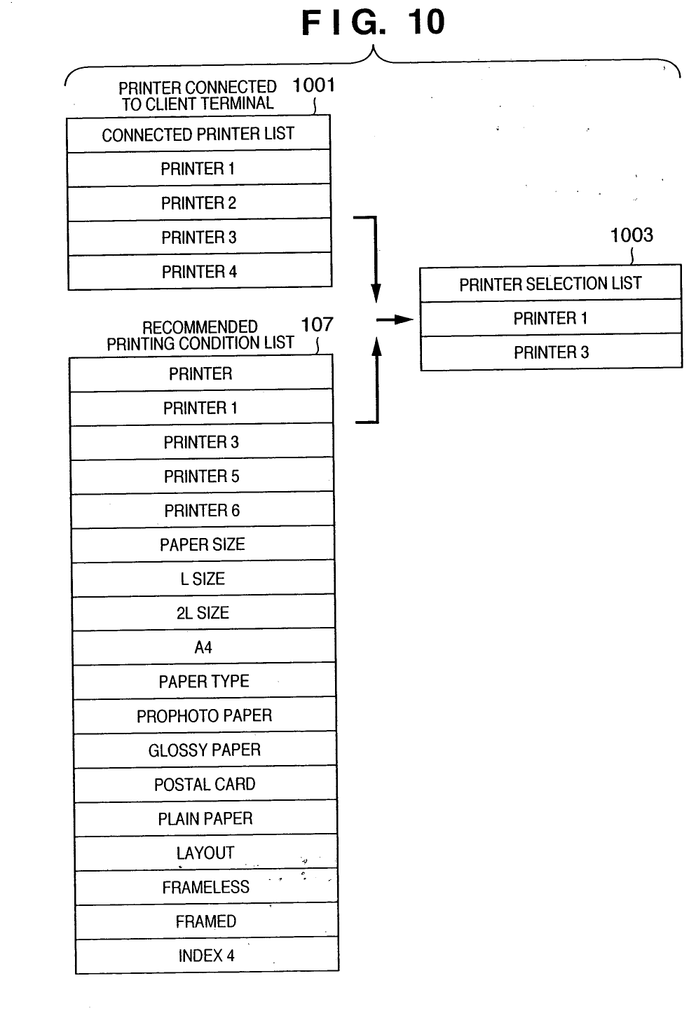

FIG. 10 is a view showing a data example to explain creating processing of a printing condition selection list, which is plug-in processing in the information processing apparatus according to the first embodiment of the present invention. For example, referring to FIG. 10, reference numeral 1001 denotes a client terminal connection printer data (second list data) which is used by the plug-in 113 to manage information about the model of the printer 115 connected to the client terminal apparatus 111, which is acquired through the operating system (OS), as a list. FIG. 10 shows “PRINTER 1”, “PRINTER 2”, “PRINTER 3”, and “PRINTER 4”.

The information processing apparatus according to this embodiment is therefore characterized in that the apparatus can be connected to at least one printing apparatus through a network, and second list data can be acquired by plug-in processing on the basis of information obtained from at least one of the OS and control software for each printing apparatus.

Referring to FIG. 10, “PRINTER 1”, “PRINTER 3”, “PRINTER 5”, and “PRINTER 6” are shown in the recommended printing condition list 107.

In this case, the plug-in 113 sets a printer selection list 1003 (third list data) by calculating the “AND (logical product)” between the client terminal connection printer data 1001 and information about printer models shown in the recommended printing condition list 107. That is, the operator of the server apparatus 101 can permit printing operation using only one of the printers 115 connected to the client terminal apparatus 111 which is included in the recommended printing condition list.

That is, the information processing apparatus according to this embodiment processes information written in a language which can describe the design of a window to be displayed by the browser, and receives the first list data transmitted from another apparatus (e.g., the server apparatus 101) connected through a network. A characteristic feature of this information processing apparatus is that it incorporates a function expansion program (plug-in 113) of the WWW browser 112, acquires the second list data, creates the third list data on the basis of the acquired second list data and the received first list data, and creates information for making the browser display a window based on the created third list data.

In addition, a characteristic feature of this embodiment is that the function expansion program of the WWW browser 112 performs a set operation between the acquired second list data and the received first list data, and creates the third list data from the operation result.

Furthermore, a characteristic feature of this embodiment is that the function expansion program of the browser creates, on the basis of the third list data, information for making the browser display an input window for various conditions of printing processing executed by a printing apparatus connected to the information processing apparatus.

The information providing apparatus (server apparatus 101) according to this embodiment has the following characteristic feature. This apparatus is connected to the client terminal apparatus 111 through the network 104, and stores the first list data which is used, together with the second list data, when the function expansion program of the browser in the client terminal apparatus 111 storing the second list data creates the third list data. In accordance with a request from the client terminal apparatus 111, the information providing apparatus transmits at least one of information written in a language which can describe the design of a window to be displayed by the WWW browser 112 and the stored first list data through the network 104.

The information providing apparatus (server apparatus 101) according to this embodiment also has the following characterized feature. This apparatus stores the image data 103 and receives the input information input in accordance with the window displayed by the WWW browser 112 in the client terminal apparatus 111 which can be connected to at least one printer 115. On the basis of the received input information, the information providing apparatus transmits the image data 103 to the client terminal apparatus 111 which can communicate with the printer 115.

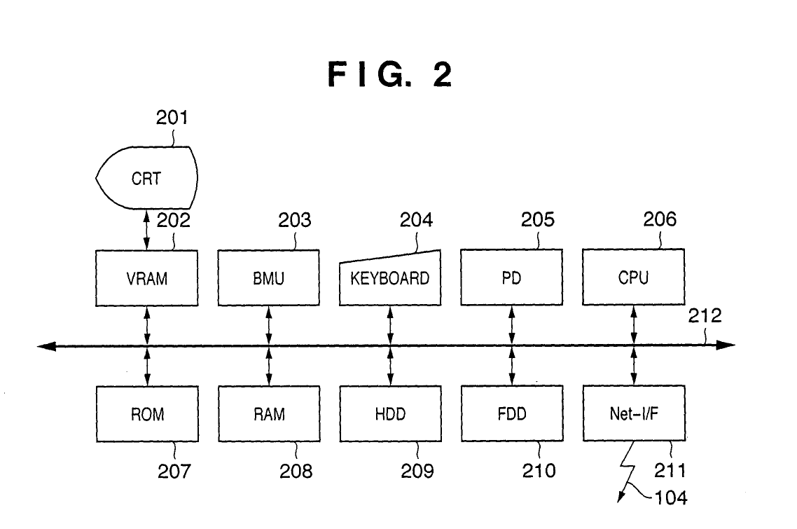

FIG. 2 is a block diagram showing the arrangement of the client terminal apparatus (information processing apparatus) according to the first embodiment of the present invention. Referring to FIG. 2, reference numeral 201 denotes a CRT (display unit) having a display screen which displays, for example, edited information such as a document, graphic pattern, and image that are being edited and user interface information such as icons, messages, and menus.

Reference numeral 202 denotes a video RAM (VRAM) 202, in which an image to be displayed on the display screen of the CRT 201 is drawn. The image data created by the VRAM 202 is transferred to the CRT 201 in accordance with a predetermined convention. With this operation, the image is displayed on the CRT 201. Reference numeral 203 denotes a bit move unit (BMU), which controls, for example, data transfer between memories (e.g., between the VRAM 202 and other memories) and data transfer between a memory and each I/O device (e.g., a network interface 211).

Reference numeral 204 denotes a keyboard having various keys for inputting documents and the like; 205, a pointing device which is used to designate, for example, an icon, menu, or another object displayed on the display screen of the CRT 201; and 206, a CPU, which controls the respective devices connected to the CPU device on the basis of the control programs stored in a hard disk or flexible disk.

Reference numeral 207 denotes a ROM which holds various kinds of control programs and data; 208, a RAM which has a work area for the CPU 206, a save area for data at the time of error processing, a load area for control programs; 209, a hard disk drive (HDD) which controls access to a hard disk; and 210, a flexible disk drive (FDD) which controls access to a flexible disk.

Reference numeral 211 denotes a network interface (Net-I/F) which can communicate with another information processing apparatus, printer, or the like through the network 104; and 212, a CPU bus including an address bus, data bus, and control bus. Control programs for the CPU 206 can be provided from the ROM 207, hard disk, and flexible disk. Alternatively, such programs can be provided from another information processing apparatus or the like through a network 213.

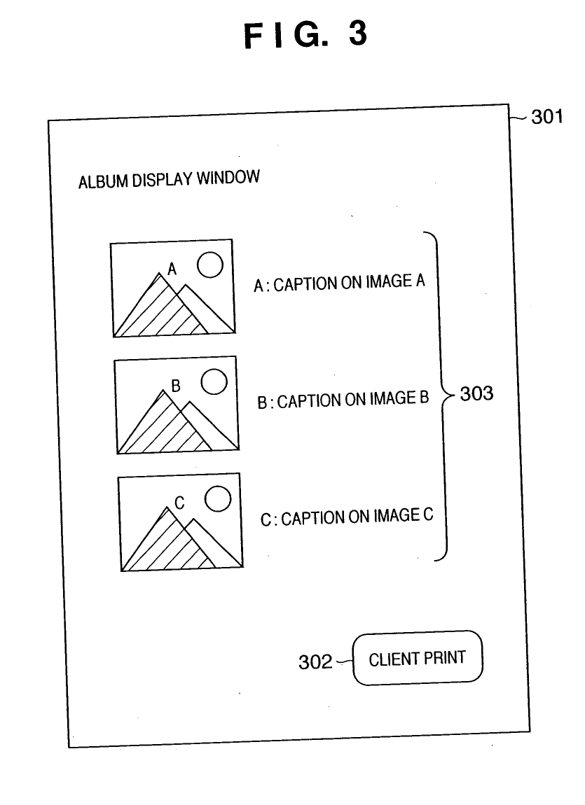

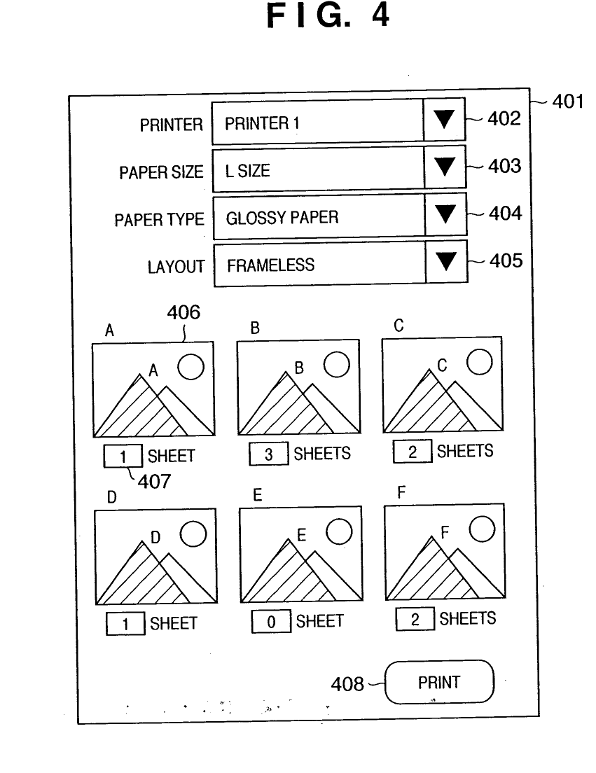

FIG. 3 is a view showing an example of an album display window according to the first embodiment. Reference numeral 301 denotes a view showing an album display window, which is a window example on the WWW browser, in which a group of image data 103 stored in the server apparatus 101 are displayed in the form of an album; 303, a portion which displays images themselves and their explanations by displaying the thumbnails of the images belonging to the album, captions on the images, and the like; and 302, a client print instruction button which designates the start of the operation of printing the images of the album using the printer 115 connected to the client terminal apparatus 111. When the client print instruction button 302 is designated by being clicked with the pointing device 205, printing control processing in this embodiment is started to display the window shown in FIG. 4.

FIG. 4 is a view showing an example of the printing operation window according to this embodiment. This printing operation window is displayed when the client print instruction button 302 in the album display window 301 is designated. Reference numeral 401 denotes a window on the WWW browser. In this window, images in the image data 103 stored in the server apparatus 101 which are designated in the album display window 301 are listed and displayed.

Reference numeral 406 denotes image data to be printed this time, which are displayed as thumbnails simply showing the images in the window 401; 402, a list box for designating and changing the printer to be used for printing; 403, a list box for designating and changing the size of paper to be used for printing; 404, a list box for designating and changing the type of paper to be used; and 405, a list box for designating and changing the layout on a paper sheet subjected to printing.

A characteristic feature of this embodiment is that the first list data, second list data, and third list data each list at least one of information about the models of printing apparatuses, information about the sizes of paper sheets subjected to printing by printing apparatuses, information about the types of paper subjected to printing by printing apparatuses, and information about layouts in printing by printing apparatuses.

Reference numeral 407 denotes an edit box for setting the number of copies of each image data 406 to be printed this time; and 408, a button which designates the execution of printing. By designating the button 408 using the pointing device 205, the user can execute printing of images to be printed this time using a designated printer with a designated type of paper, designated size, designated layout, and designated numbers of copies.

When the execution of printing is designated, the plug-in 113 is activated by the WWW browser 112. The plug-in 113 then sends a print image transfer request to the server apparatus 101 on the basis of the image file name selected as an image to be printed. The client terminal apparatus 111 acquires the image data 103 from the server apparatus 101. The client terminal apparatus 111 sends the acquired image data 103 to the printer 115 as a designated printer through the printer driver 114, thereby making the printer 115 execute printing.

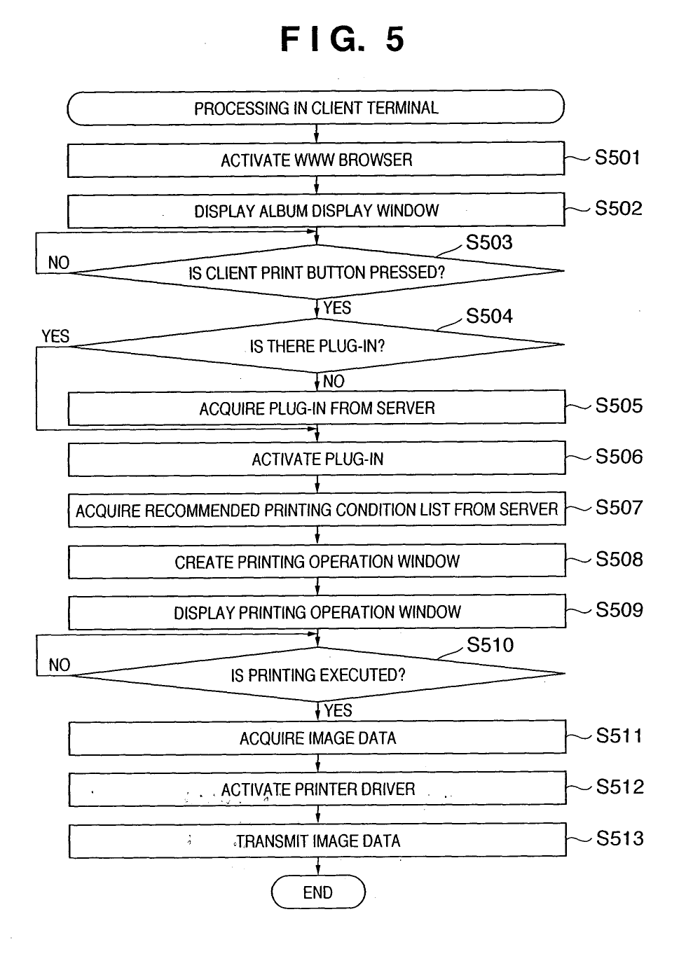

A printing sequence in the present invention will be described next with reference to flow charts and data examples. FIG. 5 is a flow chart for explaining a printing sequence in the client terminal apparatus 111 according to the first embodiment.

As shown in FIG. 5, first of all, the operator (user) selects an album including image data to be printed from the server apparatus 101 through the client terminal apparatus 111, and activates the WWW browser (step S501). The album display window 301 is then displayed (step S502).

The user presses the client print instruction button 302 in the album display window 301 (step S503). It is then checked whether any plug-in exists in the client terminal apparatus 111 (step S504). If no plug-in exists (NO), plug-in data is acquired from the server apparatus 101, and the acquired plug-in is stored in the storage unit in the client terminal apparatus 111 (step S505). The flow then advances to step S506. If a plug-in exists in the client terminal apparatus 111 (YES), the processing in step S506 is executed. Note that the client terminal apparatus 111 according to this embodiment acquires a plug-in from the server apparatus 101 or the like when no plug-in exists.

In step S506, the plug-in is activated. The plug-in acquires the recommended printing condition list 107 held in the server apparatus 101 through the network 104 (step S507). The plug-in acquires conditions under which the printer 115 connected to the client terminal apparatus 111 can perform printing, and creates the printing operation window shown in FIG. 4 (step S508). The created printing operation window is displayed on the WWW browser 112 (step S509). The user can select or input printing conditions by performing operation in accordance with the printing operation window.

The client terminal apparatus 111 checks whether the button 408 in the WWW browser 401 has been pressed by the user to input an instruction to execute printing (step S510).

If it is determined in step S510 that an instruction to execute printing is input, the plug-in 113 transmits a print image transfer request constituted by information (an image file name and the like) for identifying the image data 103 to be printed to the server apparatus 101 through the network 104. The plug-in 113 then acquires the image data 103 to be printed (step S511).

The plug-in 113 of the client terminal apparatus 111 activates the printer driver 114 corresponding to the printer 115 selected in step S509 (step S512). The plug-in 113 transmits, to the printer driver 114, the image data 103 acquired in step S511 and the printing conditions (the paper size, the type of paper, layout, and the like) selected or input in step S509 (step S513).

The printer driver 114 then creates print data on the basis of the transmitted image data and printing conditions, and transmits the data to the printer 115 selected in step S509, thereby making the printer execute printing. The printing processing in the client terminal apparatus 111 can be terminated by closing the WWW browser 112.

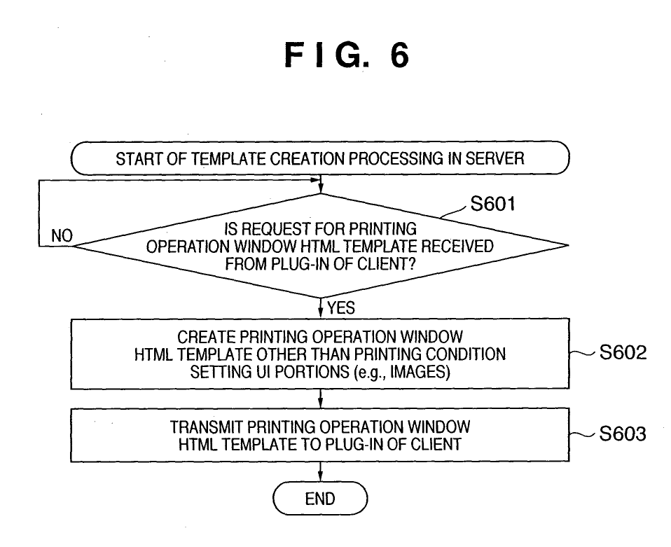

FIG. 6 is a flow chart for explaining a sequence for printing operation window HTML template creation in the server apparatus according to the first embodiment. First of all, a request for a printing operation window HTML template is received from the plug-in 113 which is creating a printing operation window in the client terminal apparatus 111 (step S601). The printing operation window HTML template creating unit 105 extracts an image required to display a printing operation window in a predetermined HTML file from the image data 103, and creates HTML data other than printing condition setting user interface portions (images and the like) necessary for a printing operation window, thereby creating the printing operation window HTML template 106 (step S602). The created printing operation window HTML template 106 is transmitted to the plug-in 113 of the client terminal apparatus 111 through the WWW serer 102 and network 104 (step S603).

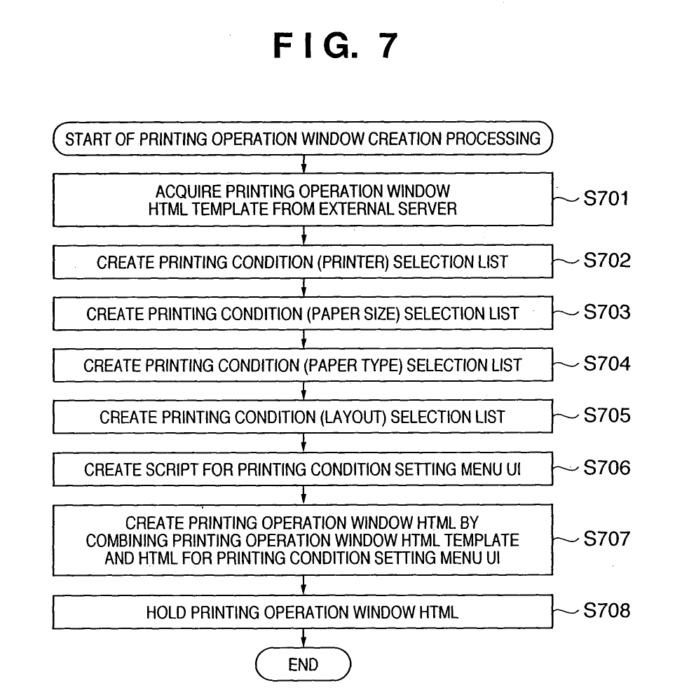

FIG. 7 is a flow chart for explaining printing operation window creation processing in the plug-in 113 of the client terminal apparatus 111. This flow chart shows the details of the printing operation window creation processing in FIG. 5 (step S508). First of all, the plug-in 113 acquires the printing operation window HTML template 106 from the server apparatus 101 (step S701).

The plug-in 113 then creates a list of printers 115 connected to the client terminal apparatus 111 through the OS, and creates a printing condition (printer) selection list by using the printer list of the recommended printing condition list 107 acquired in step S507 (step S702). The plug-in 113 acquires printable paper sizes of the respective printers in the printer selection list by inquiring of the respective printer drivers, and creates a printing condition (paper size) selection list for each printer by using the printer list of the recommended printing condition list 107 acquired in step S507 (step S703).

The plug-in 113 further acquires the types of printable paper by inquiring of the respective printer drivers, and creates a printing condition (paper type) selection list, which allows selection for each combination of a printer and a paper size, by using the printer list of the recommended printing condition list 107 acquired in step S507 (step S704). The plug-in 113 acquires printable layouts by inquiring of the respective printer drivers, and creates a printing condition (layout) selection list, which allows selection for each combination of a printer, a paper size, and a paper type, by using the printer list of the recommended printing condition list 107 acquired in the step S507 (step S705). Note that the details of printing condition selection list creation processing in steps S702 to S705 will be described later.

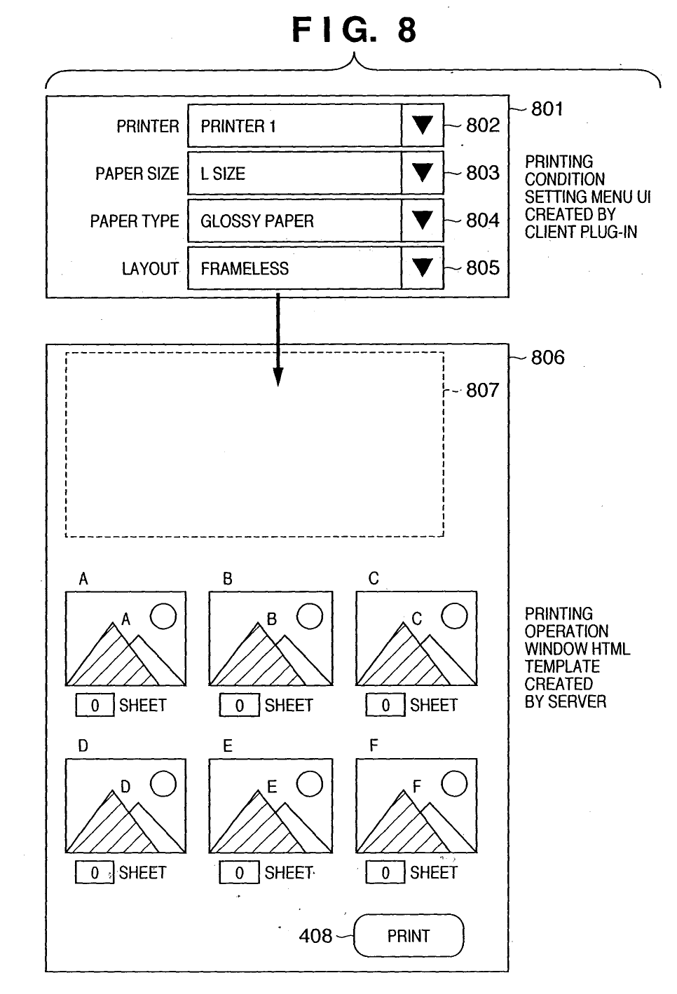

In addition, the plug-in 113 creates a menu user interface for setting the respective printing conditions by using the data of the respective selection lists created in steps S702, S703, S704, and 705 (step S706). For example, the plug-in 113 creates script for a list box that realizes a pull-down menu like the one denoted by reference numeral 801 in FIG. 8 (to be described later) for each printing condition.

The plug-in 113 inserts the printing condition setting menu user interface created in step S706 in the printing condition user interface setting portion of the printing operation window HTML template acquired from the server apparatus 101 in step S701 and combines them to create a printing operation window HTML 116 (step S707). The created printing operation window HTML 116 is held to be displayed on the WWW browser 112 (step S708).

FIG. 8 is a view showing an example of the window displayed on the WWW browser on the basis of the printing operation window HTML in the first embodiment of the present invention. This view shows an example of the data created in step S707 in FIG. 7. Referring to FIG. 8, reference numeral 801 denotes a printing condition setting menu user interface created by the plug-in in the processing in steps S702 to S706.

In the printing condition setting menu user interface 801, a printing condition (printer) selection list is displayed as choices in a printer selection menu 802. In a paper size selection menu 803, a printing condition (paper size) selection list is displayed as choices. In a paper type selection menu 804, a printing condition (paper type) selection list is displayed as choices. In a layout selection menu 805, a printing condition (layout) selection list is displayed as choices.

Reference numeral 806 denotes the printing operation window HTML template 106 acquired by the plug-in from the server apparatus 101 in step S701. In the printing operation window HTML template 806, reference numeral 807 denotes a printing condition user interface setting portion, in which the printing condition setting menu user interface 801 is inserted by the processing in step S707 and combined as the printing operation window HTML 116.

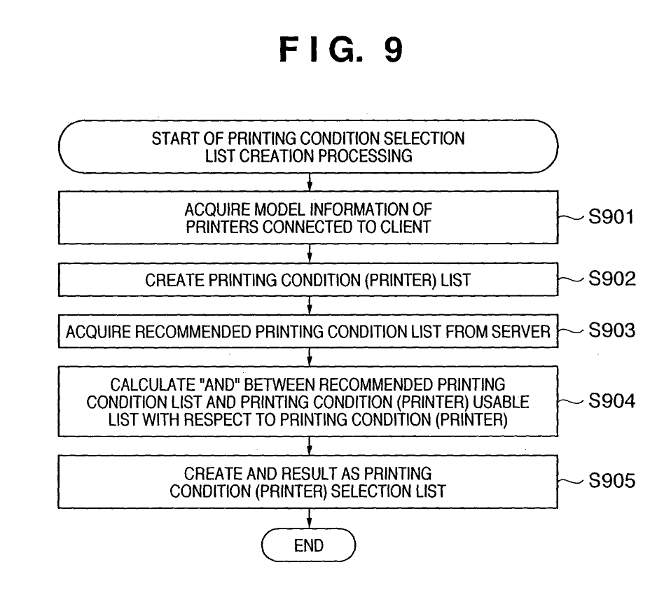

FIG. 9 is a flow chart for explaining a sequence for printing condition selection list creation which is plug-in processing in the client terminal apparatus 111 according to the first embodiment of the present invention. That is, this flow chart shows the details of steps S702 to S705 in FIG. 7 described above. Consider case wherein a printing condition selection list is created concerning printers of printing conditions.

First of all, the plug-in 113 acquires information about the models of printers 115 connected to the client terminal apparatus 111 through the OS (step S901). The plug-in 113 then creates the client terminal connection printer data 1001 shown in FIG. 10 to manage the acquired information about the models of the printers 115 in the form of a list (step S902).

The plug-in 113 acquires the recommended printing condition list 107 from the server apparatus 101 through the network 104 (step S903). The plug-in 113 then performs AND set operation between the client terminal connection printer data 1001 created in step S902 and the information about the models of the printers 115 contained in the recommended printing condition list 107 acquired in step S903 (step S904).

The plug-in 113 creates the printer selection list 1003 shown in FIG. 10 on the basis of the operation result in step S904 (step S905). Note that the respective types of printing condition selection lists can be created concerning other printing conditions (paper size, paper type, layout, and the like), as in the above case of “printer”, by executing the processing in steps S901 to S905.

As shown in FIG. 10, the recommended printing condition list 107 lists printing condition items, associated with the respective types of printing conditions, which the WWW browser 112 is permitted to use when printing image data. Referring to FIG. 10, for example, “PRINTER1”, “PRINTER3”, “PRINTER5”, and “PRINTER6” are listed concerning the models of printers which are permitted to use. Concerning paper sizes that are permitted to be used, “L size”, “2L size”, and “A4” are listed. Concerning the types of paper that are permitted to be used, “prophoto paper”, “glossy paper”, “postal card”, and “plain paper”. Concerning layouts that ate permitted to be used, “frameless”, “framed”, and “index 4” are listed.

In the information processing apparatus and information providing apparatus according to this embodiment, a printing window can be displayed by combining the recommended printing condition list acquired from the server apparatus, the printing condition setting menu user interface which the plug-in created by acquiring information from the printers on the client terminal apparatus side and performing a set operation, and the printing window template acquired from the server apparatus. This makes it possible to provide a printing operation window which eliminates the necessity to notify the server apparatus of the printer information on the client terminal apparatus side, can ensure the security on the client side, and omits unnecessary data transmission/reception to improve the data transfer efficiency without harming user's convenience. In addition, printing conditions can be limited on the client side by only changing the recommended printing condition list held in the server apparatus. This makes it possible to perform control by server operation alone so as to make the user additionally use a new printer or inhibit an application from using any improper paper size. This eliminates the necessity to change the plug-in on the client side. In addition, this can make the user use printing conditions conforming to an application. Furthermore, the server need not manage printer printing conditions that can be used by an indefinite number of clients.

According to this embodiment, the operator can print image data by using the printing operation window provided under the above advantages. In addition, according to the embodiment, since using a recommended printing condition list allow the user to use a printer within the range of printing conditions set in the server apparatus, the recommended printing condition list can be easily managed.

As described above, according to this embodiment, the server apparatus 101 can execute printing processing in accordance with the printing condition items desired by the operator of the client terminal apparatus 111 without creating a printing operation window for each client.

<Second Embodiment>

By adding a means for storing set printing conditions to printing control processing in the first embodiment, standard choices can be set for printing condition selection lists in displaying the next printing operation window.

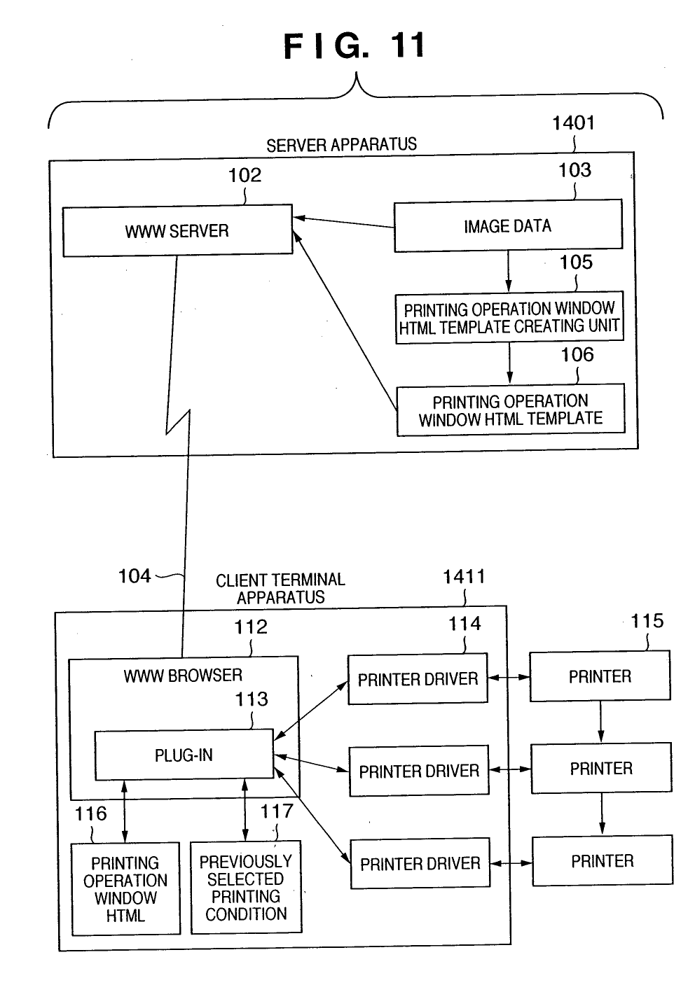

FIG. 11 is a view showing the arrangement of an information processing system having an information processing apparatus according to the second embodiment of the present invention. In the information processing apparatus (client terminal apparatus 1411) according to this embodiment, selected printing conditions 117 are added, as a file which a plug-in 113 stores and reads out, to the arrangement of the information processing apparatus according to the first embodiment. Note that the remaining portions of the client terminal apparatus 1411 are the same as those of the client terminal apparatus 111 described in the first embodiment.

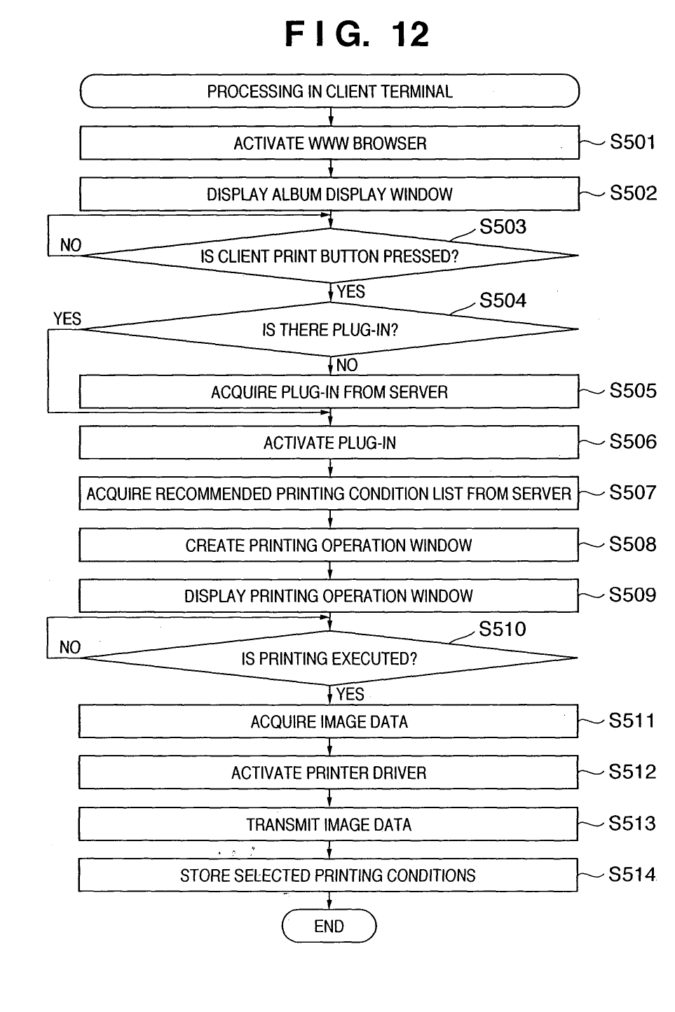

FIG. 12 is a flow chart for explaining a printing sequence in the client terminal apparatus 1411 according to the second embodiment of the present invention. Note that this flow chart is equivalent to the flow chart for explaining a printing sequence in the client terminal apparatus 111 according to the first embodiment shown in FIG. 5 to which printing condition storage processing in step S514 is added. Therefore, the processing in steps S501 to S513 is the same as that in the first embodiment. After image data is transmitted and the print result is output in step S513, the corresponding printing conditions are stored as the previously selected printing condition 117 (step S514).

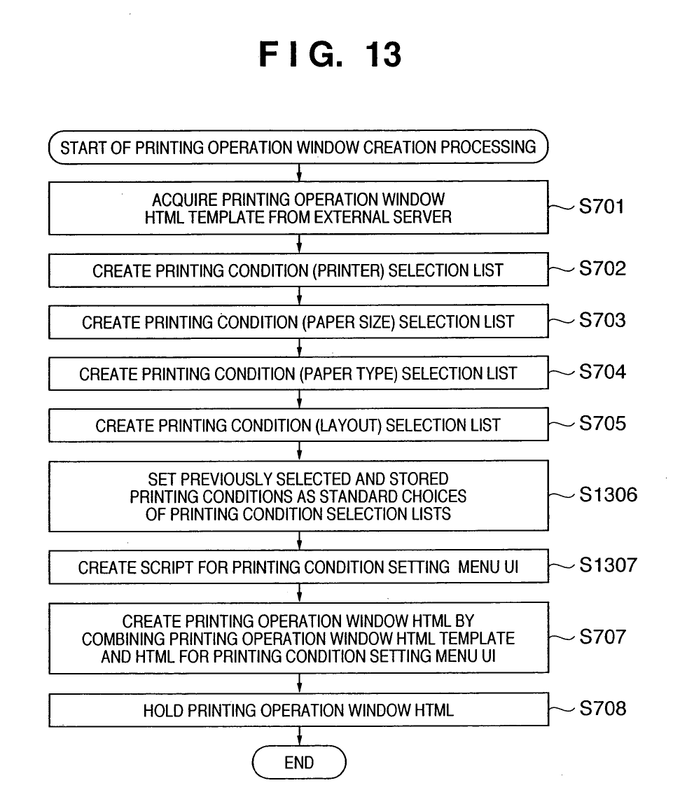

FIG. 13 is a flow chart for explaining a sequence for printing operation window creation in the plug-in of the client terminal apparatus according to the second embodiment of the present invention. This flow chart is for a sequence for loading the previously selected printing condition 117 stored in the previous printing operation and displaying a selection list with the previously selected printing conditions as standard choices in displaying a printing operation window.

Referring to FIG. 13, the processing in steps S701 to S705 is the same as that in the flow chart for the printing operation window creation processing in FIG. 7 in the first embodiment. Note that in this embodiment, the processing in step S1306 is added. In step S1306, the previously selected printing condition 117 stored in step S1214 is loaded, and the loaded conditions are set as standard choices of the respective printing condition selection lists created in steps S702 to S705.

In the case of an HTML pull-down menu, HTML data is created by the processing in step S1307 so as to display a menu in a selected state, as indicated by “401” in FIG. 4. Note that the processing in steps S707 and S708 is the same as that in the first embodiment.

As described above, according to this embodiment, in a printing operation window, the printing conditions set when the previous printing processing was executed are displayed as standard choices. When, therefore, the user is to perform printing under the same printing conditions, an operation environment can be provided, which can save labor and time in selecting printing conditions from the beginning.

The present invention can be applied to a system constituted by a plurality of devices (e.g., a host computer, interface, reader, printer) or to an apparatus comprising a signal device (e.g., a copying machine or facsimile machine).

The objects of the present invention are also achieved by supplying a recording medium (or a storage medium), which records program codes of a software program that can realize the functions of the above embodiments, to the system or apparatus, and causing a computer (or a CPU or MPU) of the system or apparatus to read out and execute the program codes stored in the recording medium. In this case, the program codes themselves read out from the recording medium realize the functions of the above embodiments, and the storage medium which stores the program code constitutes the present invention. The functions of the above embodiments may be realized not only by causing the computer to execute the readout program code but also by some or all of actual processing operations executed by an OS (operating system) running on the computer on the basis of instructions of the program codes.

Furthermore, the functions of the above embodiments may be realized by some or all of actual processing operations executed by a CPU or the like arranged in a function extension card or a function extension unit, which is inserted in or connected to the computer, after the program codes read out from the recoding medium are written in a memory of the extension card or unit.

When the above recording medium is to be applied to the present invention, program codes corresponding to the flow charts described above are stored in the recording medium.

As has been described above, according to the present invention, the server apparatus allows execution of processing of data stored in itself in accordance with the conditions desired by the operator of the server apparatus without creating information for making a browser display a predetermined window for each client apparatus. This makes it possible to provide services reflecting the intentions of the operator of the server apparatus and reducing various processing loads on the server apparatus without harming user's convenience.

The present invention is not limited to the above embodiments and various changes and modifications can be made within the spirit and scope of the present invention. Therefore, to apprise the public of the scope of the present invention, the following claims are made.

What is claimed is:

1. An information processing apparatus for processing information written in a language which can describe design of a window to be displayed by a browser, comprising:
reception means for receiving first list data transmitted from another apparatus connected through a network; and
storage means for storing a function expansion program for the browser, said function expansion program including acquisition unit adapted to acquire second list data and creation unit adapted to create the information for causing the browser to display a window based on the second list data acquired by the acquisition unit and the first list data received by said reception means.

2. The apparatus according to claim 1, wherein
the function expansion program for the browser further comprises computation unit adapted to perform a set operation between the second list data acquired by the acquisition means and the first list data received by said reception means, and
the creation unit creates on the basis of an operation result obtained by the computation unit.

3. The apparatus according to claim 1, wherein
the apparatus can be connected to at least one printing apparatus through a network, and
the acquisition means acquires the second list data on the basis of information obtained from at least one of an operating system and control software for the printing apparatus.

4. The apparatus according to claim 3, wherein the function expansion program for the browser further comprises second information creation means for creating the information for causing the browser to display an input window for various conditions for printing processing executed by the printing apparatus on the basis of the first and second list data.

5. The apparatus according to claim 3, wherein each of the first list data and the second list data lists at least one of information about a model of the printing apparatus, information about a paper size for printing by the printing apparatus, information about a paper type for printing by the printing apparatus, and information about a layout for printing by the printing apparatus.

6. An information providing apparatus connected to a client apparatus through a network, comprising:
storage means for storing first list data to be used by a function expansion program for a browser in the client apparatus which stores the second list data; and
transmission means for transmitting, through a network, at least one of information written in a language which can describe design of a window to be displayed by the browser and the first list data stored in said storage means in accordance with a request from the client apparatus.

7. The apparatus according to claim 6, further comprising
second storage means for storing image data;
reception means for receiving input information input in accordance with a window displayed by the browser in the client apparatus which can be connected to at least one printing apparatus through a network, and
second transmission means for transmitting the image data to the client apparatus on the basis of the input information received by said reception means.

8. The apparatus according to claim 7, wherein each of the first list data, the second list data, and third list data lists at least one of information about a model of the printing apparatus, information about a paper size for printing by the printing apparatus, information about a paper type for printing by the printing apparatus, and information about a layout for printing by the printing apparatus.

9. An information processing system in which an information providing apparatus and an information processing apparatus can communicate with each other through a network, wherein
the information providing apparatus comprises
first storage means for storing first list data, and
transmission means for transmitting the first list data stored in the first storage means in accordance with a request from the information processing apparatus, and
the information processing apparatus comprises second storage means for storing a function expansion program for the browser, said function expansion program including acquisition unit adapted to acquire second list data and creation unit adapted to create the information for causing the browser to display a window based on the second list data acquired by the acquisition unit and the first list data received by said reception means.

10. An information processing method in an information processing apparatus which processes information written in a language which can describe design of a window to be displayed by a browser and stores second list data, comprising:
a reception step of receiving first list data transmitted from another apparatus connected through a network;
an acquisition step of acquiring the second list data according to a function expansion program for the browser;
a creation step of creating information for causing the browser to display a window based on the second list data acquired in the acquisition step and the first list data received in the reception step.

11. A program causing a computer to execute an in processing method defined in claim 10.

12. A computer-readable recording medium storing a program defined in claim 11.

13. A function expansion program for causing a computer to process information written in a language which can describe design of a window to be displayed by a browser, wherein the program causes the computer to execute:
a procedure for acquiring first list data transmitted from another apparatus connected through a network;
a procedure for acquiring second list data from the computer; and
a procedure for creating information for causing the browser to display a window based on the first list data and the second list data.

14. A computer-readable recording medium storing a function expansion program defined in claim 13.
